(19) United States
(12) Patent Application Publication
(10) Pub. No.: US 2025/0268402 A1
(43) Pub. Date: Aug. 28, 2025

(54) FOLDABLE CARD HOLDER

(71) Applicant: American Greetings Corporation, Cleveland, OH (US)

(72) Inventor: Charles Robert Kelly, Amherst, OH (US)

(21) Appl. No.: 18/585,317

(22) Filed: Feb. 23, 2024

(51) Int. Cl. A47F 7/14

(52) U.S. Cl. CPC A47F 7/14

(57) ABSTRACT

The foldable card holder of the present disclosure and related inventions includes a base panel, a first accordion panel having a plurality of fold lines, slots, and downward-facing channels thereon, and a second accordion panel having a plurality of fold lines, slots, and upward-facing channels thereon. Where the first and second accordion panels are intertwined by inserting the downward-facing channels on the first accordion panel into the upward-facing channels on the second accordion panel, the first and second accordion panels are attached to the base panel, and where the foldable card holder can move between a first position, wherein it is folded and stacked between two portions of the base panel and a second position, wherein it is unfolded, unstacked and in an upright position.

### CROSS-REFERENCE TO RELATED APPLICATIONS

There are no applications related to this application.

### SUMMARY OF THE INVENTION

The foldable card holder of the present disclosure and related inventions includes a base panel, a first accordion panel having a plurality of fold lines, slots, and downward-facing channels thereon, and a second accordion panel having a plurality of fold lines, slots, and upward-facing channels thereon. Where the first and second accordion panels are intertwined by inserting the downward-facing channels on the first accordion panel into the upward-facing channels on the second accordion panel, the first and second accordion panels are attached to the base panel, and where the foldable card holder can move between a first position, wherein it is folded and stacked between two portions of the base panel and a second position, wherein it is unfolded, unstacked and in an upright position.

In another embodiment, the foldable card holder contains a base panel. the base panel being a rectangular-shaped elongate, substantially planar panel, and a first accordion panel and a second accordion panel, each of the first and second accordion panels having a plurality of fold lines thereon and being attached to the base panel. The first and second accordion panels are intertwined by inserting a plurality of downward facing panels on the first accordion panel into a plurality of upward facing panels on the second accordion panel. Where the base panel, the first accordion panel, and the second accordion panel can move between a first, folded, substantially flat position and a second, unfolded, upright position and one or more greeting cards can be retained on the foldable card holder by inserting said one or more greeting cards into two or more slots contained on the first and second accordion panels.

In still another embodiment, the foldable card holder includes a base panel, and an accordion structure attached to the base panel, the accordion structure comprising a first accordion panel and a second accordion panel. Where the accordion structure contains a plurality of slots contained thereon and the base panel and the accordion structure are moveable between a first position, wherein they are in a substantially flat, folded position, and a second position, wherein they are in an upright, unfolded position, and where when the base panel and accordion structure are in the second position, one or more greeting cards may be retained on the accordion structure by inserting the one or more greeting cards into a pair of the plurality of slots contained on the accordion structure.

### BRIEF DESCRIPTION OF DRAWINGS

FIG. 1 is a perspective view of the card holder, with greeting cards place therein.

FIG. 2 is a perspective view of the card holder of FIG. 1, without greeting cards.

FIG. 3 is an exploded view of the card holder of FIG. 2.

FIG. 4 is a perspective view of the card holder of FIG. 2, in mid-fold.

FIG. 5 is a front view of FIG. 4

FIG. 6 is a top view of the card holder of FIG. 2.

FIG. 7 is a perspective view of the card holder of FIG. 2, in a folded state.

FIG. 8 is a side view of the card holder of FIG. 7.

### DETAILED DESCRIPTION OF THE INVENTION

The foldable card holder (also referred to herein as “card holder”) 100 of the present disclosure and related inventions is a foldable display that can move between a first or folded, substantially flat position to a second or unfolded, fully upright position. The card holder 100 is a functional decor item that includes a base panel B, two accordion panels A, C and various accessory panels AP. In the first or folded position, the card holder 100 is collapsed between two segments of the base panel B, forming a flat, stacked, rectangular form. When the card holder 100 is opened into the second or unfolded, fully upright position, it forms a flat, elongate, rectangular shape with intertwined accordion panels A, C attached thereto. Portions of the accordion panels A, C contain several spaced apart slots S thereon that facilitate insertion of a portion of one or more greeting cards GC therein for display.

The card holder 100 is foldable into a rectangular form, like a greeting card, and can be retained in an envelope for storage between seasons or for mailing as a gift to a recipient. The card holder 100 is a great alternative to current methods of displaying greeting cards, such as using tape or magnets to display greeting cards on walls or refrigerators, as there are no extra pieces or parts that can be inadvertently lost or unattached or that can damage walls or other display surfaces. The card holder 100 is also sturdy and safely retains each greeting card GC on the card holder 100, unlike placing individual greeting cards on a shelf or table where they consistently get knocked over or fall to the floor.

In the embodiment described herein and shown in the figures, the card holder 100 is made of paperboard, however other materials have been contemplated and can be used as long as they are of a similar strength and flexibility as paperboard. The base panels B may be made of a harder or more protective material such as cardboard, however other materials can be used. The card holder 100 may have printing thereon in a holiday theme or motif or can have a more general, non-specific theme for use all year around.

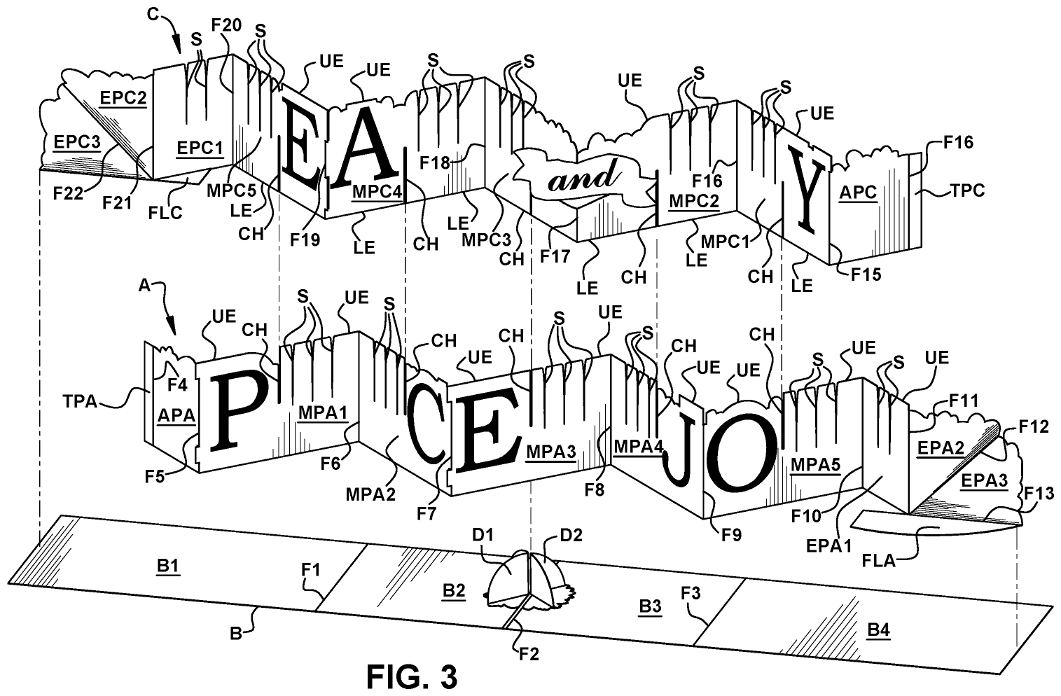

The base panel B of the card holder 100 is divided into four subpanels which are contiguous and divided by three fold lines. A first panel B1 is attached to a second panel B2 along fa first fold line F1. The second panel B2 is attached to a third panel B3 along a second fold line F2. The third panel B3 is attached to a fourth panel B4 along a third fold line F3. The first B1 and fourth B4 sub-panels are rectangular and are equal in size and the second B2 and third B3 subpanels are square and are equal in same size, with the first B1 and fourth B4 subpanels being larger than the second B2 and third B3 subpanels, as shown in FIG. 3. Each of the base subpanels have a first surface and a second surface opposite the first surface.

The card holder 100 contains two accordion panels A, C. The first accordion panel A includes a tab panel TPA attached to an attachment panel APA along a fold line F4. The attachment panel APA is attached to a first main subpanel MPA1 along a fold line F5. The first main subpanel MPA1 is attached to a second main subpanel MPA2 along a fold line F6. The second main subpanel MPA2 is attached to a third main subpanel MPA3 along a fold line F7. The third main subpanel MPA3 is attached to a fourth main subpanel MPA4 along a fold line F8. The fourth main subpanel MPA4 is attached to a fifth main subpanel MPA5 along a fold line F9. The fifth main subpanel MPA5 is attached to a first portion of an end panel EPA along a fold line F10. The first portion of the end panel EPA1 is attached to a second portion of the end panel EPA2 along a fold line F11. The second portion of the end panel EPA2 is attached to a third portion of the end panel EPA3 along fold line F12. The third portion of the end panel EPA3 is attached to flap FLA along fold line F13.

Similarly, the second accordion panel C includes a tab panel TPC that is attached to an attachment panel APC along a fold line F14. The attachment panel APC is attached to a first main subpanel MPC1 along a fold line F15. The first main subpanel MPC1 is attached to a second main subpanel MPC2 along a fold line F16. The second main subpanel MPC2 is attached to a third main subpanel MPC3 along a fold line F17. The third main subpanel MPC3 is attached to a fourth main subpanel MPC4 along a fold line F18. The fourth main subpanel MPC4 is attached to a fifth main subpanel MPC5 along a fold line F19. The fifth main subpanel MPC5 is attached to a first portion of an end panel EPC1 along a fold line F20. The first portion of the end panel EPC1 is attached to a second portion of the end panel EPC2 along a fold line F21. The second portion of the end panel EPC2 is attached to a third portion of the end panel EPC3 along a fold line F22. The third portion of the end panel EPC3 is attached to a flap FL2 along a fold line F23. Each of the two accordion panels A, C have a first surface and a second surface opposite the first surface.

A variety of slots S are contained on each accordion panel A, C, to facilitate the removable attachment of one or more greeting cards GC to and from the card holder 100. A variety of channels CH are also contained on each accordion panel A, C to facilitate attachment of the first accordion panel A to the second accordion panel C. The variety of channels CH are slightly wider than the variety of slots S. Each of the slots S contained on the first and second accordion panels A, C extend from an upper edge UE of the panel A, C down into the panel A, C to the approximate vertical midpoint thereof. Each of the main subpanels MPA1, MPA2, MPA3, MPA4, MPA5, MPC1, MPC2, MPC3, MPC4, MPC5 contain three (3) slots S thereon and each end panel EPA, EPC contain two (2) slots S thereon. Each of the channels CH on the first accordion panel A extend from an upper edge UE of the panel A down into the panel A. Each of the main subpanels MPA1, MPA2, MPA3, MPA4, MPA5 of the first accordion panel A contain a single channel CH which is located at the approximate horizontal midpoint thereof. Each of the channels CH on the second accordion panel C extend from a lower edge LE of the panel C up into the panel C. Each of the main subpanels MPC1, MPC2, MPC3, MPC4, MPC5 of the second accordion panel C contain a single channel CH which is located at the approximate horizontal midpoint thereof.

Two (2) stabilizing discs D1, D2 are attached to base panels B2, B3, respectively, to facilitate attachment of the first and second accordion panels A, C to the base panels B.

To assemble the card holder 100, the first and second accordion panels A, C can be attached to the base panel by affixing the flap FLA contained on the first accordion panel A to the fourth base panel B4 and affixing the flap FLC contained on the second accordion panel C to the first base panel B1. The first and second accordion panels A, Care then connected to each other by affixing tab TPB to the outside surface of the first portion of the end panel EPA1, proximate fold line F11 and affixing tab TPA to the outside surface of the first portion of the end panel EPC1, proximate fold line F21. The first and second accordion panels A, C can now be intertwined by placing the downward facing channels CH on main subpanels MPC1, MPC2, MPC3, MPC4, and MPC5 into the upward facing channels CH on main subpanels MPA5, MPA4, MPA3, MPA2, and MPA1, respectively. To further stabilize and secure the first and second accordion panels A, C to the base panel B, the two stabilizing discs D1, D2 are used to create an attachment point between the two accordion panels A, C, and the center of the base panel B.

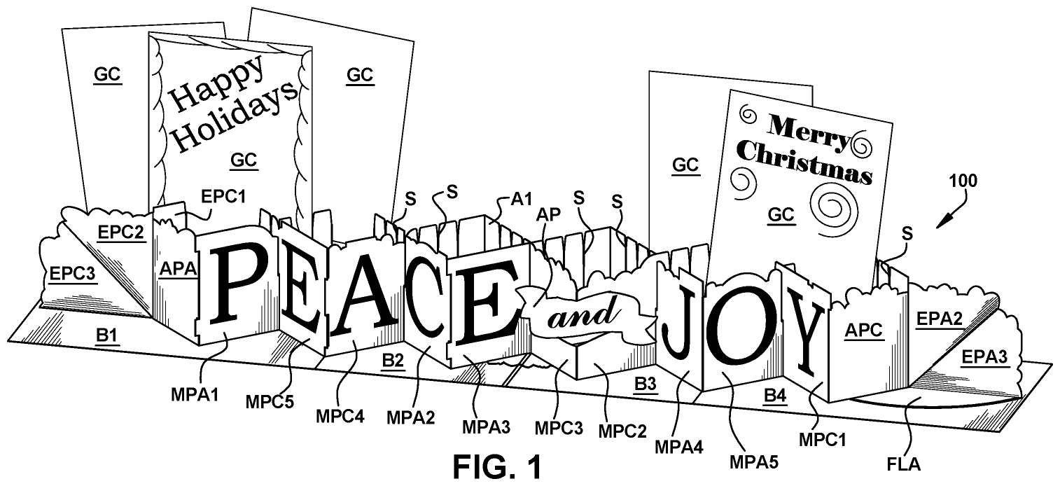

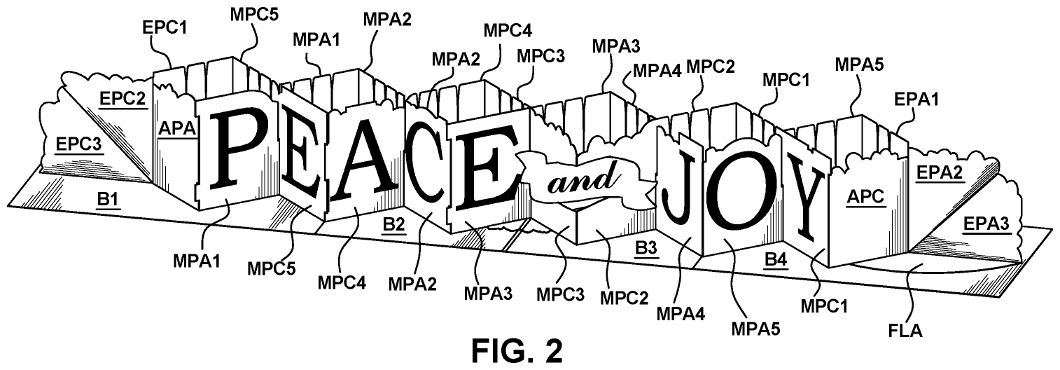

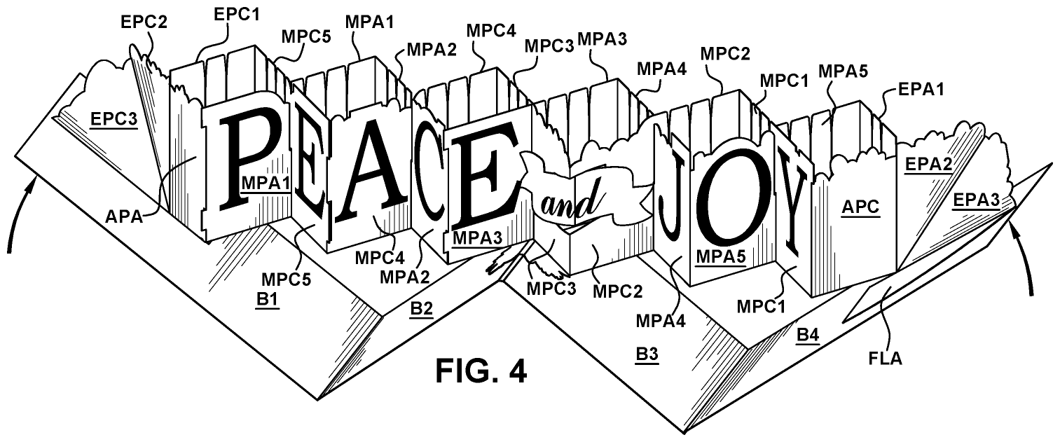

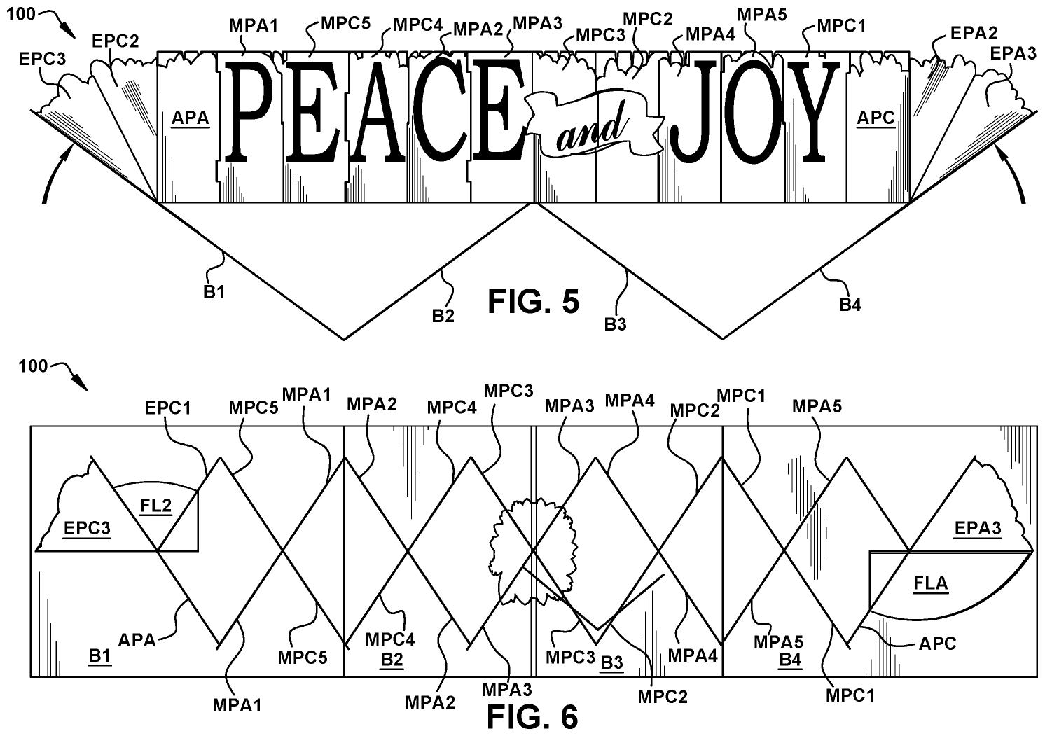

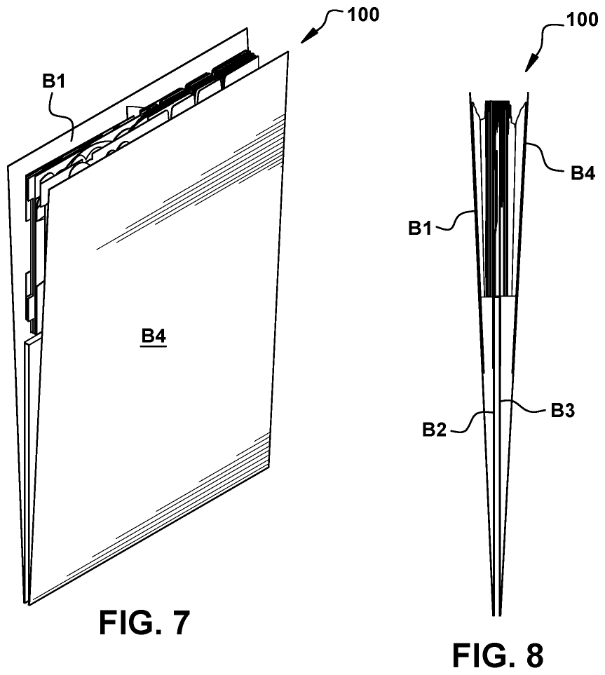

In operation, the card holder 100 is in a first position (shown in FIGS. 7 and 8), wherein it is stacked and folded substantially flat between the first base panel B1 and the fourth base panel B4. Pulling the first base panel B1 and the fourth base panel B4 away from each other by pivoting about fold line F1 and F3 (shown in FIG. 4), unfurls the card holder 100 into the second position, wherein it is unstacked, unfolded and in an upright position (shown in FIG. 2). The outer surface of the base panel B is downward facing and placed atop a flat surface such as a tabletop or shelf. The intertwined accordion panels A, C create six (6) attached diamond or rhombus shapes (shown in FIG. 6) with the slotted sides of each accordion panel A, C on one side of the card holder 100 and non-slotted sides of each accordion panel A, C on the opposite side of the card holder 100. Greeting cards GC can be placed onto the card holder by placing the lower edge of the greeting card GC into the opposing slots contained on two sides of the diamond or rhombus shapes, as shown in FIG. 1. When the card holder 100 is in the second, folded position, it can easily be placed into an envelope for storage or for mailing to a recipient. It is reusable so it can be stored and then brought out each season.

While the card holder of the present disclosure and related inventions has been described herein with respect to a preferred embodiment, this embodiment is only an example of one way the card holder may look or be implemented. The embodiment disclosed herein has been described as having accordion panels having a certain number of main subpanels (5), however, the card holder may be made with a fewer number (or shorter) main subpanels or a greater number (or longer) main subpanels. Also, the number of slots contained on each accordion panel or on each main subpanel may be fewer or greater in other embodiments. Of course, the number of slots, channels, fold lines and panels can be different from what has been described herein with respect to one embodiment.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

1. A foldable card holder comprising:
a base panel;
a first accordion panel having a plurality of fold lines, slots, and downward-facing channels thereon;
a second accordion panel having a plurality of fold lines, slots, and upward facing channels thereon;
wherein the first and second accordion panels are intertwined by inserting the downward-facing channels on the first accordion panel into the upward-facing channels on the second accordion panel; and
wherein the first and second accordion panels are attached to the base panel;
wherein the foldable card holder can move between a first position, wherein it is folded and stacked between two portions of the base panel and a second position, wherein it is unfolded, unstacked and in an upright position.

2. The foldable card holder of claim 1, wherein the base panel contains two fold lines and four subpanels.

3. The foldable card holder of claim 1, wherein when the card holder is in the second position, the first and second intertwined accordion panels form a plurality of diamond- or rhombus-shaped structures.

4. The foldable card holder of claim 3, wherein the diamond- or rhombus-shaped structures each have slots contained on two sides thereof.

5. The foldable card holder of claim 1 further comprising two stabilizing discs which connect the two accordion panels to the center of the base panel.

6. The foldable card holder of claim 1, wherein the card holder can display at least six greeting cards thereon.

7. A foldable card holder comprising:
a base panel, the base panel being a rectangular-shaped elongate, substantially planar panel;
a first accordion panel and a second accordion panel, each of the first and second accordion panels having a plurality of fold lines thereon and being attached to the base panel;
the first and second accordion panels being intertwined by inserting a plurality of downward facing panels on the first accordion panel into a plurality of upward facing panels on the second accordion panel;
wherein the base panel, the first accordion panel, and the second accordion panel can move between a first, folded, substantially flat position and a second, unfolded, upright position; and
wherein one or more greeting cards can be retained on the foldable card holder by inserting said one or more greeting cards into two or more slots contained on the first and second accordion panels.

8. The foldable card holder of claim 7 further comprising at least one stabilizing disc which attaches the first and second accordion panels to the base panel.

9. The foldable card holder of claim 7, wherein when the first and second accordion panels are in the second position, they create at least six diamond- or rhombus-shaped structures.

10. The foldable card holder of claim 9, wherein the at least six diamond- or rhombus-shaped structures contain slots on at least two sides thereof.

11. The foldable card holder of claim 7 wherein the first accordion panel contains five (5) downward-facing channels thereon.

12. The foldable card holder of claim 7, wherein the second accordion panel contains five (5) upward-facing channels thereon.

13. The foldable card holder of claim 7, wherein each of the first and second accordion panels contain at least 17 slots thereon.

14. The foldable card holder of claim 7, wherein the first accordion panel is attached to a first end of the base panel and the second accordion panel is attached to a second end of the base panel, opposite the first panel.

15. A foldable card holder comprising:
a base panel;
an accordion structure attached to the base panel, the accordion structure comprising a first accordion panel and a second accordion panel;
wherein the accordion structure contains a plurality of slots contained thereon;
wherein the base panel and the accordion structure are moveable between a first position, wherein they are in a substantially flat, folded position, and a second position, wherein they are in an upright, unfolded position;
wherein when the base panel and accordion structure are in the second position, one or more greeting cards may be retained on the accordion structure by inserting the one or more greeting cards into a pair of the plurality of slots contained on the accordion structure.

16. The foldable card holder of claim 15, wherein the first and second accordion panels are attached by placing a plurality of downward-facing channels on the first accordion panel onto the plurality of upward-facing channels on the second accordion panel.

17. The foldable card holder of claim 15 further comprising at least one stabilizing disc which attaches the center of the accordion structure to the center of the base panel.

18. The foldable card holder of claim 15, wherein the first accordion panel is attached to a first end of the base panel and the second accordion panel is attached to the second end of the base panel, opposite the first end.

19. The foldable card holder of claim 15, wherein the accordion structure forms at least six (6) diamond- or rhombus-shaped structures when in the second position.

20. The foldable card holder of claim 19, wherein the at least six (6) diamond- or rhombus-shaped structures contain slots on at least two sides thereof.
